(19) United States
(12) Patent Application Publication
(10) Pub. No.: US 2005/0260243 A1
(43) Pub. Date: Nov. 24, 2005

(54) Method of treating microbial plant diseases

(75) Inventors: Michael Lynch, Hollywood, FL (US); Rudyard Istvan, Fort Lauderdale, FL (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/113,506

(22) Filed: Apr. 25, 2005

Related U.S. Application Data
(60) Provisional application No. 60/565,337, filed on Apr. 26, 2004.

(51) Int. Cl. A01N 25/34; A01N 25/00; A01N 37/00

(52) U.S. Cl. 424/405; 514/557

(57) ABSTRACT

Microbiocidal method for treating and preventing infections in plants, said method employing antimicrobial compositions comprising an organic acid or organic acid mixture and a short-chain anionic surfactant having at least one of a large head group; a branched alkyl chain and an unsaturated alkyl chain.

### CROSS REFERENCE TO RELATED APPLICATION

This application claims the benefit of U.S. Provisional Application No. 60/565,337, filed Apr. 26, 2004.

### FIELD OF THE INVENTION

The present invention relates to a microbiocidal method for treating and preventing infections in plants.

### BACKGROUND OF THE INVENTION

Plants are affected by a number of common disease of microbial origin. Citrus Canker is a bacterial disease of citrus trees caused by the gram negative bacteria Xanthomonas campestris. This disease is highly contagious and is responsible for signficant economic damage by causing premature dropping of leaves and fruit. It overwinters in diseased trees and is spread when it oozes from scabs during wet weather. Wind driven rain is the primary mode of transmission. The bacterium is well suited to spread in the warm wet areas where citrus grows freely. Because there is currently no effective treatment, efforts to eradicate the disease have been destruction of infected trees and all other citrus trees within a 1,900 foot radius.

X. campestris is a gram negative bacterium belonging to the biochemically versatile gamma Proteobacteria. Canker bacteria are aerobic and do not form spores. This bacteria overwinters in diseased trees and are spread when it oozes from scabs during wet weather. Wind driven rain is its primary mode of transmission. The bacterium is well suited to spread in the warm wet areas where citrus grows freely.

Microbiocidal compounds of various chemical compositions have been used on plants to inhibit or kill microorganisms that have a detrimental effect on the plant. These microorganisms include bacteria, yeasts and fungi. However, conventional microbiocides have several drawbacks.

The application of large quantities of a biologically active antimicrobial compound also creates an environmental hazard. Many of the conventional antimicrobial compounds are not quickly degraded and will remain in the environment for relatively long periods of time. These biologically active compounds can cause severe damage as the concentration of the compound increases due to multiple applications to plants.

Microbiocides that are used to treat fruits, vegetables and grains can be introduced into the food chain where they are eventually consumed by humans. As the concentration of these microbiocidal compounds increases in the food chain, the detrimental effect on humans and animals is increased.

The antimicrobial compounds currently available are often genus specific. A different chemical compound may be required to treat each genus of microorganism found on a planet. Each multiply-infected plant must therefore receive a series of treatments to effectively protect from or eliminate all of the harmful microorganisms.

### SUMMARY OF THE INVENTION

Antimicrobial compositions comprising an organic acid or organic acid mixture, a specific short-chain anionic surfactant with branching or a large head group, and, optionally, a calcium ion scavenger and/or anti-foam agents are described and claimed in U.S. patent publications 20030235550 A1, 20040001797A1, and in published PCT application WO 2004/000016 the content of which are incorporated herein by reference.

### DETAILED DESCRIPTION OF THE INVENTION

Preferred Compositions

Antimicrobial compositions that provide enhanced immediate and residual anti-viral and antibacterial efficacy against rhinovirus, rotavirus, Gram-positive bacteria, Gram-negative bacteria and combinations thereof are taught in U.S. patent publications 20030235550 A1, 20040001797A1, and in published PCT application WO 2004/000016 the content of which are incorporated herein by reference. These compositions were stated to have efficacy against gram negative and gram positive bacteria and also against viruses. We believe that certain formulations of these short chain, big head surfactant based antimicrobial compositions will be effective against a wide variety of pathenogenic agricultural organisms including but not limited to citrus canker.

These antimicrobial compositions comprise an organic acid or organic acid mixture, a specific short-chain anionic surfactant with branching or a large head group, and, optionally, a calcium ion scavenger and/or anti-foam agents. For therapeutic use the formulations require in addition to the surfactant, an organic acid acid and a nonionic agent. Preferred is to use C8-AGS as the surfactant, pyrrolidone carboxyilic acid as the organic acid and ethylhexyl glycerol ether (EHOP) as the non-ionic agent. One of skill in the art will recognize that other agents as disclosed in 20030235550 A1, 20040001797A1, or WO 2004/000016 may be substituted. Preferred are compositions having greater than about 0.50% C8AGS with most preferred compositions containing at least 1.25% C8AGS and a pyrrolidone carboxyilic acid content of greater than or equal to 2.0%.

One of skill in the art will readily recognize that other active ingredients can be included to provide different properties or to improve the effectiveness of the present compositions against specific organisms. When adding other actives, the concentration of surfactants, acids and/or non-ionic agents would also be modified to provide the degree of activity desired. For example, Parachlorometaxylenol (PCMX), a known antimicrobial may be added to provide another broad spectrum antimicrobial. For example when adding PCMX, it is possible to reduce the amount of C8AGS below 1% concentration by weight.

TABLE 1

| | Formula | | | | |
|---|---|---|---|---|---|
| Active Component (Wt %) | R | M | H | KS | KSM |
| C8-AGS | 0.50 | 1.25 | 2.00 | 0.60 | 1.00 |
| Coco Sulfofatty Acid | | | | 0.40 | |
| Gluconic Acid | 2.00 | | | | |
| Pyroglutamic Acid (PCA) | | 2.00 | 15.00 | 3.50 | 3.00 |
| Succinic Acid | | | | 1.50 | 2.00 |
| Ethylhexyl Glyceryl | | 0.55 | 1.00 | 0.50 | 0.50 |
| Ether (EHOP) | | | | | |
| Parachlorometaxylenol | | | | 0.35 | 0.50 |
| (PCMX) | | | | | |
| Potassium Sorbate | | | | 0.10 | |

Formulation

The composition of the present invention may be formulated for use in any manner known to one of skill in the art. Formulations for topical, mucosal and aerosol delivery of drugs are taught in Modern Pharmaceutics by Gilbert S. Banker (Editor), Christopher T. Rhodes (Editor) Marcel Dekker; 4th edition (Jun. 15, 2002) ISBN: 0824706749, all of which is incorporated herein by reference. Reference is also made to the International Journal of Pharmaceutical Compounding which can be accessed at www.ijpc.com, the content of which is incorporated herein by reference. These sources teach and describe the basics of pharmaceutical compounding. One of skill in the art will know how to take the active ingredients of the present invention and formulate them for delivery. Such formulations may take the form of lotions, ointments, gels, creams, drops washes, pastes, suppositories, lozenges, mouthwashes, gargles, douches, foams, surface coatings, liposomes, microspheres and transdermal patches.

One of skill in the art will appreciate that the activity of the present compositions can be affected through the selection of excipients to provide varying degree of skin penetration or to control release. Activity of the present formulations can be increased by occlusion of the skin after application with a suitable bandage or wrap. One of skill in the art will also recognize that persistent action can be increased by use of controlled release technologies which delay release of active over time.

The formulations contemplated herein can also be coated or otherwise incorporated into medical devices such as wipes, sponges, bandages, surgical drapes, hospital gowns, surgical gowns. Formulations can be developed that are suitable for disinfecting medical devices. Such formulations could be in the form of a liquid which could be used for spraying onto surfaces, soaking of devices, pumping through devices or incorporated into wipes for decontaminating a surface.

Testing

The formulations described above were tested for Minimum Bactericidal Dilution and Residual efficacy against C. Albicans, E. Coli, S. marcesens, Methicillin Resistant Staphylococcus aureus, and E. faecalis,

Minimum Bactericidal Dilution

The above compositions from table 1 were tested for Minimum Bactericidal Dilution. Organisms to be tested were grown on slants and transferred to an agar plate by streaking to form a lawn. Colonies are scraped off the agar plates using a sterile innoculating loop and suspended in phosphate buffered solution (PBS) and diluted to 5×10⁶ CFU/ml.

TABLE 1

| | | MINIMUM BACTERICIDAL DILUTION | | | | | | |
|---|---|---|---|---|---|---|---|---|
| | | | E. faecalis | | | | | S. aureus |
| | Test | C. albicans | (VRE) | E. coli | P. aeruginosa | S. marcescens | S. aureus | (MRSA) |
| HTR # | Article | 10231 | 51299 | 11229 | 15442 | 14756 | 6538 | 33591 |
| 1 | 0.1% | No | 1:8 | 1:8 | 1:16 | 1:2 | Undiluted | Undiluted |
| | EHOP, | Inhibition | | | | | | |
| | 1.25% | | | | | | | |
| | AGS, | | | | | | | |
| | 8.5% PCA, | | | | | | | |
| 2 | 1% EHOP, | No | 1:2 | 1:16 | 1:8 | 1:4 | No | Undiluted |
| | 0.5% | Inhibition | | | | | Inhibition | |
| | AGS, | | | | | | | |
| | 2% PCA | | | | | | | |
| 3 | 0.1% | No | 1:4 | 1:16 | 1:16 | 1:4 | 1:2 | 1:2 |
| | EHOP, 2% | Inhibition | | | | | | |
| | AGS, | | | | | | | |
| | 15% PCA | | | | | | | |
| 4 | 0.1% | No | Undiluted | Undiluted | 1:2 | 1:8 | Undiluted | 1:4 |
| | EHOP, | Inhibition | | | | | | |
| | 0.5% | | | | | | | |
| | AGS, 15% | | | | | | | |
| | PCA | | | | | | | |
| 5 | 0.1% | No | 1:4 | 1:2 | 1:8 | 1:8 | 1:2 | 1:8 |
| | EHOP, 2% | Inhibition | | | | | | |
| | AGS, | | | | | | | |
| | 2% PCA | | | | | | | |
| 6 | 0.55% | No | 1:32 | 1:4 | 1:1024 | 1:8 | Undiluted | 1:16 |
| | EHOP, | Inhibition | | | 1:4 | | | |
| | 1.25% | | | | 1:4 | | | |
| | AGS, | | | | | | | |
| | 15% PCA | | | | | | | |
| 7 | 0.1% | No | Undiluted | 1:8 | 1:8 | Undiluted | No | No |
| | EHOP, | Inhibition | | | | | Inhibition | Inhibition |
| | 0.5% | | | | | | | |
| | AGS, | | | | | | | |
| | 2% PCA | | | | | | | |
| 8 | 1% EHOP, | Undiluted | 1:32 | 1:32 | 1:64 | 1:64 | 1:16 | 1.2 |
| | 2% AGS, | | | | | | | |
| | 15% PCA | | | | | | | |
| 9 | 1% EHOP, | No | 1:16 | 1:16 | 1:8 | 1:8 | 1:16 | 1:16 |
| | 2% AGS, | Inhibition | | | | | | |
| | 2% PCA | | | | | | | |
| 10 | 0.55% | Undiluted | 1:16 | 1:32 | 1:4 | 1:2 | 1:4 | 1:8 |
| | EHOP, 2% | | | | | | | |
| | AGS, | | | | | | | |
| | 8.5% PCA | | | | | | | |
| 11 | 1% EHOP, | Undiluted | Undiluted | 1:2 | 1:4 | 1:4 | 1:4 | 1:8 |
| | 1.25% | | | | | | | |
| | AGS, | | | | | | | |
| | 8.5% PCA | | | | | | | |
| 12 | 0.55% | Undiluted | 1:2 | 1:8 | 1:16 | 1:2 | 1:4 | 1:8 |
| | EHOP, | | | | | | | |
| | 1.25% | | | | | | | |
| | AGS, | | | | | | | |
| | 8.5% PCA | | | | | | | |
| | | | | | 1:4 | | | |
| | | | | | 1:2 | | | |
| 13 | 0.55% | No | 1:16 | 1:8 | 1:4 | 1:4 | 1:4 | 1:4 |
| | EHOP, | Inhibition | | | | | | |
| | 1.25% | | | | | | | |
| | AGS, 2% | | | | | | | |
| | PCA | | | | | | | |
| 14 | 0.55% | No | 1:2 | Undiluted | 1:8 | 1:4 | Undiluted | Undiluted |
| | EHOP, | Inhibition | | | | | | |
| | 0.5% | | | | | | | |
| | AGS, | | | | | | | |
| | 8.5% PCA | | | | | | | |
| 15 | 1% EHOP, | No | Undiluted | Undiluted | 1:4 | 1:16 | Undiluted | Undiluted |
| | 0.5% | Inhibition | | | | | | |
| | AGS, | | | | | | | |
| | 15% PCA | | | | | | | |
| 16 | 0.55% | No | 1:8 | 1:16 | 1:32 | 1:32 | Undiluted | 1:2 |
| | EHOP, | Inhibition | | | | | | |
| | 1.25% | | | | | | | |
| | AGS, | | | | | | | |
| | 8.5% PCA | | | | | | | |
| | | | | | 1:4 | | | |
| | | | | | Undiluted | | | |
| 17 | 0.55% | No | 1:32 | 1:8 | 1:2048 | 1:32 | 1:8 | Undiluted |
| | EHOP, | Inhibition | | | | | | |
| | 1.25% | | | | | | | |
| | AGS, | | | | | | | |
| | 8.5% PCA | | | | | | | |
| | | | | | 1:4 | | | |
| | | | | | 1:8 | | | |
| 18 | 0.55% | No | 1:256 | 1:16 | 1:32 | 1:8 | 1:4 | 1:8 |
| | EHOP, | Inhibition | | | | | | |
| | 1.25% | | | | | | | |
| | AGS, | | | | | | | |
| | 8.5% PCA | | | | | | | |
| | | | 1:2 | | 1:4 | | | |
| | | | 1:2 | | 1:4 | | | |
| 19 | 0.55% | No | 1:8 | 1:4 | 1:256 | 1:2 | Undiluted | 1:2 |
| | EHOP, | Inhibition | | | | | | |
| | 1.25% | | | | | | | |
| | AGS, | | | | | | | |
| | 8.5% PCA | | | | | | | |
| | | | | 1:2 | 1:4 | | | |
| | | | | 1:2 | 1:4 | | | |
| 20 | 0.55% | No | 1:16 | 1:32 | 1:2048 | 1:2 | Undiluted | 1:2 |
| | EHOP, | Inhibition | | | | | | |
| | 1.25% | | | | | | | |
| | AGS, | | | | | | | |
| | 8.5% PCA | | | | | | | |
| | | | | | 1:16 | | | |
| | | | | | 1:4 | | | |
| 21 | ChloraPrep | 1:4 | 1:4 | 1:64 | 1:2 | 1:2 | 1:32 | 1:8 |

In Vitro Time Kill

Candida Albicans was cultured under appropriate conditions. (current USP procedures for culturing organisms is appropriate.) Incubation period varies (typically 120 hours at 25° C.+/−1° C.) to a density of between 1.0E+06−1.0E+07 CFUs/mL. Actual CFUs/mL of starting cultures were determined by serially diluting and plating an aliquot (typically plate 10⁻⁶, 10⁻⁵, 10⁻⁴, 10⁻³, 10⁻² dilutions). A 50 μl aliquot of the yeast culture was pipetted into 5.0 mL of the antimicrobial solution(s) in a sterile scintillation vial (organisms: solution ratio=1:100) and mixed thoroughly by vortexing. Test inoculum level was ˜1.0E+04−1.0E+05 CFUs/mL. At the predetermined time point(s), 1 min, 5 min, and 10 min, a 0.5 mL aliquot of the inoculated antimicrobial solution is pipetted into 4.5 mL of Dey/Engley (D/E) neutralizing broth (ratio=1:10) and mixed by vortexing. An aliquot of the neutralized sample including yeast was plated onto a Sabouaud Dextrose Agar (SDA) plate using standard pour plate techniques. The SDA plates were incubated at 25° C.+/−1° C. for 5 days (˜120 hours) and CFU's are counted. CFUs/mL for organism cultures are calculated and compared to CFUs/mL for antimicrobial solutions to determine the log reductions.

Residual Efficacy Testing

Residual efficacy testing was performed by evenly coating the surface of a skin patch with 20 μl of the active solution. Skin samples were allowed to evaporate for 1 minute, 15 minutes, 60 minutes, 120 minutes, 240 minutes, 360 minutes, 480 minutes, and 14 hours with the lid off the Petri plate. At the appropriate time point, skin samples were inoculated with 10 μl of a 1:10 dilution of the 18-hour microbial suspension (˜1.0E+08 CFUs/mL), evenly covering the entire area and the sample recovered and allowed to sit 5 minutes. At this time the skin was extracted using sterile forceps and placed in a steril centrifuge tube. Containing 10 ml of a sampling solution and vortexed for 30 seconds. An aliquot of the extracted sample containing any microbials from the skin was plated onto a trypticase soy agar plate using a spiral plater (typically 50 μl in exponential mode). The agar plates were incubated at 37° C. overnight (˜18 hours) and CFUs are counted. CFUs/mL established by Baseline Count are calculated and compared to CFUs/mL for antimicrobial/bacterial solutions to determine the log reductions. The Baseline Count was achieved by evenly spreading 10 μl of the diluted bacterial suspension on a square of the skin and processed in accordance with the above procedure, except no active solution was added. One of skill in the art will appreciate that this test can be repeated with any substrate including but not limited to bark, leaves, flowers, fruit, roots, etc.

Test results

Anti-Fungal/Yeast Activity

Formulas R, M, H, KS and KSM were tested against Candida albicans and compared for activity with Chloraprep. The antifungal properties of these formulations were previously untested and unknown. In vitro time kill testing was performed as described above. The result of the testing are set forth in Table 2.

TABLE 2
In vitro time-kill of C. albicans 10231

| | Minutes of contact | | |
|---|---|---|---|
| | time (log reduction | | |
| | from log 5.0 titer) | | |
| Formula sample | 1 | 5 | 10 |
| ChloraPrep (70% alcohol + | 4.8 | 4.8 | 4.8 |
| 2% CHG) | | | |
| KSM | 4.8 | 4.8 | 4.8 |
| M | 1.3 | 4.8 | 4.8 |
| RID | 0.3 | 0.9 | 1.0 |

Residual Skin efficacy testing against C. albicans was performed as set forth above. The data are set forth in Table 3 below.

TABLE 3
Candida albicans (C. albicans 10231) Residual Efficacy

| Log Reduction | Chlora-prep | RID | M | H | KS | KSM |
|---|---|---|---|---|---|---|
| 1 min | 3.6 | 0.8 | 2.3 | 3.4 | 3.6 | 3.6 |
| 15 min | 2.2 | 1.1 | 2.7 | 3.9 | 3.6 | 3.6 |
| 60 min | 2.5 | 0.9 | 2.9 | 3.9 | 3.6 | 3.6 |
| 120 min | 1.8 | 2.1 | 3.2 | 3.9 | 3.6 | 3.6 |
| 240 min | 1.1 | 0.2 | 2.7 | 3.9 | 3.6 | 3.6 |
| Complete kill = Log 4 | | | | | | |

The above data show that medically acceptable strengths of RID kill candida. Faster kill, but not more residual activity can be obtained by adding known broad spectrum antimicrobial (PCMX).

E. Coli

Formulas R, M, H, KS and KSM were tested against E. coli and compared with Chloraprep. Residual Skin efficacy testing against E. Coli was performed as set forth above. The data are set forth in Table 4 below.

TABLE 4
E. coli (E. coli 11229) Residual efficacy testing.

| Log Reduction | Chlora-prep | RID | M | H | KS | KSM |
|---|---|---|---|---|---|---|
| 1 min | 4.6 | 0.6 | 4.6 | 4.6 | 4.6 | 4.6 |
| 15 min | 4.5 | 2.7 | 4.6 | 4.6 | 3.7 | 4.5 |
| 60 min | 4.1 | 4.5 | 4.6 | 4.6 | 4.6 | 4.6 |
| 120 min | 3.3 | 3.7 | 4.6 | 4.2 | 4.6 | 4.6 |
| 240 min | 3.9 | 4.0 | 4.6 | 4.1 | 4.6 | 4.6 |

Serratia marcesens (S. marcesens 14756)

Formulas R, M, H, KS and KSM were tested against S. marcesens and compared with Chloraprep. Residual Skin efficacy testing against S. marcesens was performed as set forth above. The data are set forth in Table 5 below.

TABLE 5
S. marcesens 14756 Residual Efficacy Results

| Log Reduction | Chlora-prep | RID | M | H | KS | KSM |
|---|---|---|---|---|---|---|
| 1 min | 1.8 | 0.1 | 3.6 | 6.0 | 5.1 | 5.1 |
| 15 min | 0.7 | 0.1 | 3.6 | 6.0 | 5.1 | 5.1 |
| 60 min | 2.0 | 0.9 | 2.0 | 6.0 | 4.5 | 5.1 |
| 120 min | 1.1 | 0.0 | 3.7 | 6.0 | 5.1 | 5.1 |
| 240 min | 1.0 | 0.2 | 2.8 | 6.0 | 5.1 | 5.1 |
| Complete kill = Log 6 | | | | | | |

Methicillin Resistant Staphylococcus aureus (MRSA)

Formulas R, M, H, KS and KSM were tested against MRSA and compared with Chloraprep. Residual Skin efficacy testing against MRSA was performed as set forth above. The data are set forth in Table 6 below.

TABLE 6
MRSA (S. aureus 33591) Residual Efficacy Results

| Log Reduction | Chlora-prep | R | M | H | KS | KSM |
|---|---|---|---|---|---|---|
| 1 min | 5.5 | 1.3 | 0.9 | 4.9 | 5.1 | 5.1 |
| 15 min | 1.4 | 0.2 | 0.6 | 3.9 | 5.0 | 4.9 |
| 60 min | 2.7 | 0.1 | 0.6 | 2.9 | 5.8 | 4.9 |
| 120 min | 3.9 | 0.3 | 1.3 | 4.0 | 4.8 | 4.5 |
| 240 min | 3.7 | 0.4 | 1.7 | 4.6 | 5.0 | 4.8 |
| Complete kill = Log 6 | | | | | | |

Vancomycin Resistant Enterococci (VRE)

Formulas R, M, H, KS and KSM were tested against E. faecalis and compared with Chloraprep. Residual Skin efficacy testing against E. faecalis was performed as set forth above. The data are set forth in Table 7 below.

TABLE 7
VRE (E. faecalis 51299) Residual Efficacy Results

| Log | Chlora- | | | | | |
|---|---|---|---|---|---|---|
| Reduction | prep | RID | GMP/M | GMP/H | GMP/KS | GMP/KSM |
| 1 min | 4.3 | 0.5 | 4.7 | 4.7 | 4.8 | 4.8 |
| 15 min | 1.1 | 1.3 | 4.5 | 4.7 | 4.8 | 4.8 |
| 60 min | 1.5 | 2.0 | 4.7 | 4.7 | 4.8 | 4.8 |
| 120 min | 1.7 | 2.8 | 4.7 | 4.7 | 4.6 | 4.8 |
| 240 min | 3.2 | 0.6 | 4.7 | 4.7 | 4.8 | 4.8 |

The plant microbiocidal composition of the present invention is expected to be effective against all known plant pathogens including but not limited to the citrus canker bacterium Xanthomonas campestris. pv citri. The plant microbiocidal compounds of the present invention would be applied to a plant in an aqueous mixture by any conventional means, such as by spraying. After the compound is applied to citrus trees, the trees are protected against infection by the X. campestris organism.

The antimicrobial of the present invention is preferrably applied to plants as an aqueous solution. The plant microbiocidal compound of the present invention can be applied to a plant by conventional techniques, such as by spraying or by fogging. The plant microbiocidal compound of the present invention can also be painted on a plant.

The following examples will serve to further illustrate the present invention without, at the same time, however, constituting any limitation thereof.

### EXAMPLE I

Solutions of the plant microbiocidal compound from Table 1 would be sprayed on citrus tree seedlings with both juvenile and mature foliage and observed for phytotoxicity. Observations would be made daily for changes to leaves, buds, branches, trunk or roots.

### EXAMPLE II

To test for eradication of the citris canker bacterium (Xanthomonas campestris pv. citri) from artificially inoculated test surfaces the antimicrobial compound from Example I would be applied to several surfaces. Proposed surfaces include kraft paper, which represents a porous inanimate surface, and unwashed citrus fruit to test sanitizing capability on a citrus fruit surface. Inoculum concentration would be 106cells/ml in water, which is approximately the highest concentration of citrus canker organisms that can be expected to be found exuding from the natural lesions.

After 10 minutes on paper or 2 minutes on fruit, the test surfaces would be swabbed with sterile cotton swabs and streaked out on nutrient agar. Untreated controls would also be tested. In each test, the test surface would be replicated three times. A sterile water rinse would be applied to the surface of the fruits and checked for surviving X. campestris cells by transferring a small amount on a sterile cotton swab to nutrient agar.

### EXAMPLE III

Seeds of red winter wheat (Arrowhead Mills, Inc. Hereford Tex.) could be soaked in an aqueous solution of the plant microbiocidal compound of the present invention for 15 minutes or thirty minutes. The seeds would be air dried, planted in peat pots and exposed to 16 hours of artificial light daily. Observations would be made each day to determine the percent of seeds that sprout, the average time to sprout, and the average growth rate.

It should be understood, of course, that the foregoing relates only to a preferred embodiment of the present invention and that numerous modifications or alterations can be made therein without departing from the spirit and the scope of the invention as set forth in the appended claims.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention.

It is therefore intended to cover in the appended claims all such changes and modifications that are within the scope of this invention.

1. A method of treating or preventing a microbial caused infection in a plant in need thereof comprising administering an effective amount of antimicrobial composition comprising: a. from about 0.2% to about 70% of an organic acid; and b. from about 0.1% to about 40% of an anionic surfactant mixture having i. a linear alkyl chain length of from about C₄ to about C₁₂ and a total head group size of at least about 4 Angstroms; and/or ii. a branched alkyl chain length of from about C₄ to about C₁₂; and/or iii. a branched alkyl chain length of from about C₄ to about C₁₂ and a total head group size of at least about 4 Angstroms; wherein said composition is characterized by a pH of from about 2.0 to about 4.5.

2. The method of claim 1, wherein said anionic surfactant is selected from the group consisting of: alkyl glyceryl sulfonate, alpha sulfo fatty acid, alkyl phosphonate, branched alkyl sulfonate and branched alkyl benzene sulfonate, secondary alkyl sulfate, mono ester of alkyl sulfosuccinic acid, alkyl isethionate, alkyl amidosulfonate, and combinations thereof.

3. The method of claim 1, further wherein said anionic surfactant is substituted with a sulfonate, sulfate or phosphonate group.

4. The method of claim 1 wherein said organic acid is selected from the group consisting of: pyroglutamic acid, adipic acid, gluconic acid, gluconolactone acid, glutamic acid, glutaric acid, glycolic acid, tartaric acid, ascorbic acid and combinations thereof.

5. The method of claim 1, wherein the antimicrobial composition further comprises a nonionic agent.

6. The method of claim 5, wherein said nonionic agent is selected from the group consisting of: 1-(2-ethylhexyl)glycerol ether, octyl glycerol ether, 2-(2-ethylhexylxoxy) propanol, octyloxy-propanol, 1-(2-ethylhexyloxy)ethanol, octyloxy ethanol, 1,2-hexylenediol, 1,2-cyclohexanedimethanol, isopropyl glycerol ether and combinations thereof.

7. The composition of claim 5, wherein said nonionic agent is present in an amount of about 0.1% to about 10% by weight of total composition.

8. The method of claim 1 wherein the microbial infection is caused by at least one of the following: Yeast, molds, bacteria or viruses.

9. The method of claim 8 where in the yeast is a Candida strain.

10. The method of claim 8 wherein the bacteria is either a gram negative or a gram positive

11. A method of disinfecting agricultural implements comprising treating a device with an effective amount of an antimicrobial composition comprising: a. from about 0.2% to about 70% of an organic acid; and b. from about 0.1% to about 40% of an anionic surfactant mixture having i. a linear alkyl chain length of from about C₄ to about C₁₂ and a total head group size of at least about 4 Angstroms; and/or ii. a branched alkyl chain length of from about C₄ to about C₁₂; and/or iii. a branched alkyl chain length of from about C₄ to about C₁₂ and a total head group size of at least about 4 Angstroms; wherein said composition is characterized by a pH of from about 2.0 to about 4.5.

12. The method of claim 11 wherein the antimicrobial composition is applied as a wash, spray, soak, or a wipe.
